(19) United States
(12) Patent Application Publication
(10) Pub. No.: US 2006/0003229 A1
(43) Pub. Date: Jan. 5, 2006

(54) Rechargeable electrochemical cell

(76) Inventors: Chung Sai-Cheong, Kanagawa (JP); Yuri Nakayama, Kanagawa (JP); Kazuhiro Noda, Kanagawa (JP); Tsuyonobu Hatazawa, Tokyo (JP)

Correspondence Address: FROMMER LAWRENCE & HAUG, 745 FIFTH AVENUE- 10TH FL., NEW YORK, NY, 10151, US

(21) Appl. No.: 10/532,947

(22) PCT Filed: Oct. 28, 2003
(86) PCT No.: PCT/JP03/13789

§ 371 Date: Apr. 27, 2005

Related U.S. Application Data
(60) Provisional application No. 60/421,949, filed on Oct. 29, 2002.

(51) Int. Cl. H01M 4/46; H01M 4/48; H01M 10/40

(52) U.S. Cl. 429/231.6; 429/231.5; 429/330; 429/334; 252/182.1

(57) ABSTRACT

An electrochemical cell is provided, including an anode, a cathode, and an electrolyte therebetween. The anode contains magnesium in a reduced state, and the cathode includes a rutile structure. The rutile structure is capable of intercalating magnesium ions received from the anode to produce a low voltage. The electrochemical cell is rechargeable. Additionally, the electrochemical cell is cheaper, more environmentally friendly and has a higher volume density than related art electrochemical cells. A method of manufacture is also provided.

### CROSS-REFERENCE TO RELATED APPLICATION

This application claims benefit and priority from the following application: U.S. Provisional Application No. 60/421,949, filed Oct. 29, 2002, the contents of which is incorporated herein by reference.

### TECHNICAL FIELD

The present invention relates to the field of rechargeable electrochemical cells, and a method of manufacture thereof. More specifically, the present invention relates to a cathode having a rutile structure configured to intercalate magnesium ions that are received from the anode, and a method of manufacturing the cathode.

### BACKGROUND ART

In the related art, a rechargeable electrochemical cell, also commonly referred to as a battery, includes a cathode, an anode, and an electrolyte therebetween. The related art anode contains a metal in reduced form, such as lithium (Li), in a graphite composite structure. The related art cathode contains a host capable of intercalating the ionic form of the metal. The electrolyte between the anode and the cathode is made of any well-known electrolyte, such as Li[(CF₃SO₂)₂N]₂. For example, U.S. Pat. No. 6,277,522 B1 (hereafter “Omaru”), the contents of which is incorporated herein by reference, discloses various aspects of the related art lithium ion rechargeable battery. Further, Omaru discloses additional related art features of the lithium ion secondary battery, including the formation of the anode, and the carbon fibers therein.

At the related art cathode, the host may be a substance such as cobalt dioxide (CoO₂). Alternatively, nickel or manganese may be used as a substitute for cobalt, or mixed therein to produce a cathode material that is a metal mixture having the formula LiCoₓM_{y}O₂, and a spinel structure. Further, a related art rutile structure in the form of titanium dioxide may be used. With rutile and the lithium ion, diffusion is highly anisotropic. Along the crystallographic c-axis, diffusion is very fast at an ambient temperature, on the order of 10⁻⁶ cm²s⁻¹. However, movement in the a-b planes substantially perpendicular to the c-axis is much slower, by about 8 orders of magnitude.

The use of rutile with lithium in electrochemical cells has various problems and disadvantages. For example, but not by way of limitation, due to at least the substantially lower volume density of lithium, there is an upper limitation on the voltage of the battery, and the produced voltage is too low for effective use in products that require lithium batteries. As a result, rutile is not as effective of a cathode host as the above-described cobalt oxides.

Further, lithium batteries generally have various problems and disadvantages. For example, but not by way of limitation, lithium has a high cost, which increases the cost of batteries to the consumer. Further, lithium has a low volume density. As a result, it is necessary to make the lithium batteries larger, which increases the overall size of the product, and results in an inconvenience to the consumer. Additionally, manufacturing cost for the manufacturer increases due to additional materials used. Further, lithium is not considered to be environmentally friendly, and therefore poses significant environment risks when disposal is required.

As an environmentally friendly, cost-effective alternative to lithium, magnesium (Mg) has been proposed for use in related art rechargeable electrochemical cells. The magnesium ion has a size of 0.49 angstroms, which is comparable that of the lithium ion, at 0.59 angstroms. As a result, it would appear that host materials used with lithium would also form a stable phase with magnesium, assuming that the transition metal in the host possesses a stable Mn⁺/Mn⁺² redox couple. However, because magnesium has a lower mobility than lithium due to its (+2) charge, as discussed below, magnesium does not work with the related art cathode hosts commercially used in lithium batteries, such as the aforementioned related art cobalt metal mixtures.

More specifically, the related art host cathode materials used with lithium do not work well with magnesium, at least because the double positive charge of magnesium interacts strongly with host ions through coulombic interaction. Because the high charge to size ratio makes the magnesium ion highly polarizing, a covalent bond forms with the negative ions of the host. Also, magnesium has a substantially lower mobility than lithium, and moves too slowly for use with lithium host cathode materials. Thus, movement of the magnesium ion is severely limited in the preferred related art hosts for cathodes used in the aforementioned related art lithium batteries.

Accordingly, a different related art host has been proposed for use with related art magnesium rechargeable electrolytic cells. A cathode having a chevrol phase, such as Mo₆S₈, or molybdenum sulfide, has been used in the related art magnesium battery, with reduced magnesium at the anode. However, this related art scheme has various problems and disadvantages. For example, but not by way of limitation, the chevrol phase host does not include oxygen, but instead uses sulfur, which has a substantially lower oxidizing power than oxygen. Therefore, there is a problem in that the voltage is low and cannot be increased. As a result, the related art magnesium battery is inefficient.

Additionally, in the related art magnesium battery, there is a problem in that the charge capacity for the chevrol phase is low. Three molybdenum atoms are required for each magnesium atom. This high cathode metal to magnesium ratio has the effect of decreasing charge capacity. Accordingly, in the related art, there is no magnesium rechargeable electrochemical cell having an oxide as the cathode material.

Therefore, for use with magnesium rechargeable electrochemical cells, there is an unmet need for a cathode having a host with higher voltage, charge capacity and volume density than the foregoing related art scheme.

### DISCLOSURE OF INVENTION

It is an object of the present invention to overcome at least the aforementioned problems and disadvantages of the related art.

To achieve at least this object and other objects, an electrochemical cell is provided that includes a first terminal material having at least one magnesium ion, and a second terminal material having a rutile structure capable of intercalating the at least one magnesium ion.

In another exemplary, non-limiting embodiment of the present invention, a rechargeable electrochemical cell is provided, including an anode configured to store at least one magnesium ion, and a cathode comprising a rutile structure configured to intercalate the at least one magnesium ion.

In yet another exemplary, non-limiting embodiment of the present invention, an electrode material for an electrochemical cell is provided. The electrode material has a rutile structure and is capable of intercalating at least one magnesium ion.

Also, a method of making a cathode material provided. This method includes the steps of forming rutile nanoparticles having a shape and a size, and enhancing electrical conductivity of the rutile nanoparticles by mixing the rutile nanoparticles to form a composite.

### BRIEF DESCRIPTION OF DRAWINGS

The above and other objects and advantages of the present invention will become more apparent by describing in detail preferred exemplary embodiments thereof with reference to the accompanying drawings, wherein like reference numerals designate like or corresponding parts throughout the several views, and wherein:

FIG. 1 illustrates an electrochemical cell according to an exemplary, non-limiting embodiment of the present invention;

FIG. 2 illustrates a unit cell of the rutile structure according to an exemplary, non-limiting embodiment of the present invention;

FIG. 3 illustrates a graphical comparison of relative energy for the movement of the related art lithium ion with respect to the magnesium ion according to an exemplary, non-limiting embodiment of the present invention;

FIGS. 4-6 illustrate a graphical representation of computed band structures comparing the exemplary, non-limiting embodiment of the presently claimed invention with the related art scheme; and

FIG. 7 illustrates a method of making the electrochemical cell according to an exemplary, non-limiting embodiment of the present invention.

### MODES FOR CARRYING OUT THE INVENTION

Referring now to the accompanying drawings, description will be given of preferred embodiments of the invention.

In an exemplary, non-limiting embodiment of the present invention, a rutile structure that includes a metal oxide such as titanium oxide is used as a positive electrode material. The rutile structure intercalates with a magnesium ion in its +2 state (Mg⁺²). Preferably, the positive electrode material is used in a rechargeable electrochemical cell.

Unless otherwise noted, the terms herein are understood to have their ordinary meaning, as would be understood by one of ordinary skill in the art. In this application, “intercalation” includes a crystal host that keeps the same structure when a foreign ion is inserted in the crystal structure of the host, with minor stretching. Additionally, the term “magnesium ion” generally refers to the magnesium ion in its +2 state. Also, the term “insertion” is used herein interchangeably with “intercalation”. However, the present invention is not limited to the foregoing definitions.

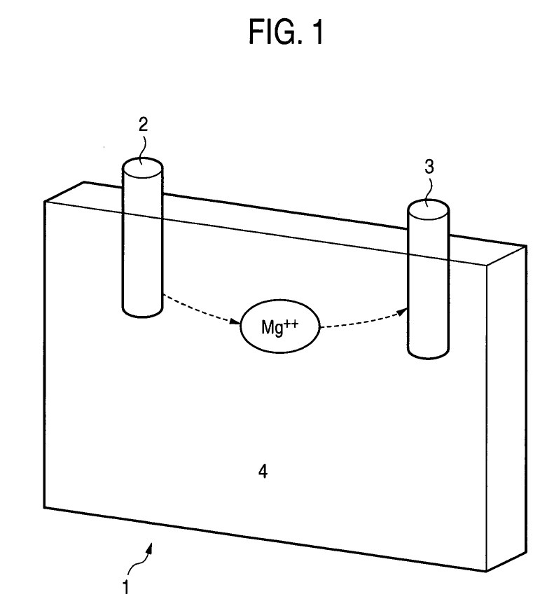

FIG. 1 illustrates an electrochemical cell 1 according to an exemplary, non-limiting embodiment of the present invention. In the electrochemical cell 1, an anode 2 having an anode material and a cathode 3 having a cathode material are provided. For example, but not by way of limitation, the anode can be a first terminal and the anode material can be a first terminal material, and the cathode can be a second terminal and the cathode material can be a second terminal material. Further, an electrolyte 4 is provided between the anode 2 and the cathode 3.

The electrochemical cell 1 is configured to be recharged (rechargeable). For example, but not by way of limitations a charge can be directed to the cathode material to reduce the magnesium ion, which then migrates to the anode. Once this process has been completed, the recharging process is complete, and the battery is ready for normal use.

The anode material at the anode 2 has a structure that includes magnesium ions in their reduced state. For example, but not by way of limitation, magnesium metal or a magnesium-containing compound may be included. In a preferred embodiment, the magnesium metal or compound is intercalated in a graphite composite structure. For example, but not by way of limitation, the magnesium metal or compound may be interposed between carbon layers.

Alternatively, titanium disulfide (TiS₂) may be used. In the present invention, any related art anode capable of intercalating magnesium in its low oxidation state (or reduced state) may be used. Theoretically, magnesium metal would be an ideal anode, and has been used under laboratory conditions. However, a practical implementation thereof has not yet been achieved, due to the problems associated with short circuiting of the electrochemical cell 1.

In another alternative, metal alloys such as MgZn₂ or MgCu₂ may be used at the magnesium anode. Additionally, magnesium metal may be used in conjunction with a single wall carbon nanotube. However, the metal alloys have a low weight density, and the carbon nanotubes have a high cost.

While the foregoing examples of anode materials are provided, the anode material of the present invention is not limited thereto.

The cathode material at the cathode 3 is made of the rutile structure. For example, but not by way of limitation, titanium dioxide (TiO₂) in a crystalline lattice is used. More specifically, the rutile is in nanoparticle form, with each nanoparticle being generally spherical in shape.

The currently available mechanical grinding technique can produce rutile having a particle diameter of between about 100 nm and about 1000 nm, depending on the exact process used. However, the currently available sol-gel technique, which is described in greater detail below, can produce a particle diameter of between about 30 nm and about 70 nm, preferably about 50 nm.

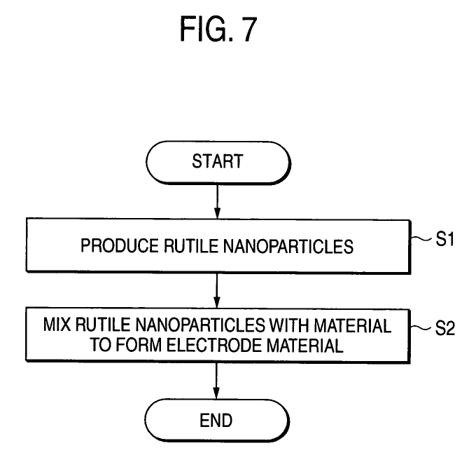

To improve conductivity, the nanoparticles are mixed with carbon. The rutile itself may be processed in a manner disclosed below and illustrated in FIG. 7 to produce the cathode of the present invention.

Alternatively, an elongated fiber may be used. For example, but not by way of limitation, the elongated fiber may be produced similar to the carbon fiber of the Omaru patent.

Optionally, the nanoparticles may be reduced to increase electronic conductivity. For example, but not by way of limitation, a defect may be created in the titanium dioxide, so that the actual formula is TiO_{2Ä}, where Ä represents an additional reduction performed on the rutile without changing its phase or chemical composition. In this reduced form, the cathode material has a higher electronic conductivity.

In an exemplary, non-limiting embodiment of the present invention, the rutile structure is made of titanium dioxide, which is electrically conductive and ionically conductive. Titanium dioxide can be intercalated with the magnesium ion at least due to its low energy of activation, which allows the magnesium ion having a relatively high mobility to be intercalated in the cathode material at the cathode 3. Also, the magnesium ion is preferred for intercalation with the rutile structure, at least due to its mass and chemical potential (reducing power).

The electrolyte 4 consists of the Mg⁺² ion, a counter anion, and a solvent. A preferred electrolyte 4 includes Mg(ClO₄)₂ (magnesium chlorate) in a propylene carbonate —(OC(O)OCH(CH₃)CH₂)— solvent in an exemplary, non-limiting embodiment of the present invention. Alternatively, the Mg(ClO₄)₂ may be in an acetonitrile (CH₃CN) solvent.

Further examples of the electrolyte 4 include, but are Mg(TFSI)₂. In this case, the formula is Mg[(CF₃SO₂)₂N]₂, or magnesium bis(trifluoromethylsulfonyl)imide) in a tetrohydrofuran (THF) solvent, which is a cyclic compound having a chemical formula of —(CH₂CH₂CH₂CH₂O)—, a dimethyl formamide (DMF) solvent, a compound having a chemical formula of (CH₃)₂NCHO, a butyrolactone solvent, which is a cyclic compound having a chemical formula of —(OC(O)CH₂CH₂CH₂)—, or the above-disclosed propylene carbonate solvent.

However, the present invention is not limited to the foregoing types of electrolytes, and other related art electrolytes may be substituted therein.

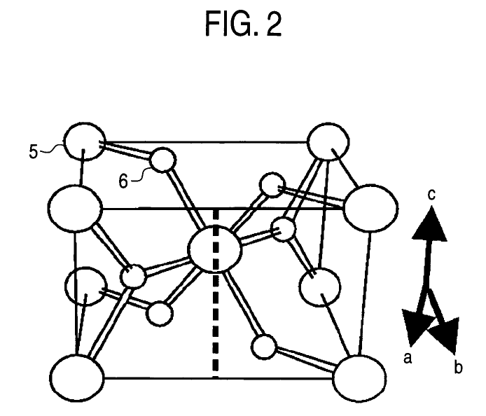

FIG. 2 illustrates-the structure of a unit cell of rutile according to an exemplary, non-limiting embodiment of the present invention. As noted above, the rutile can have a chemical formula of TiO₂. In FIG. 2, the titanium atoms are shown as reference character 5, and the oxygen atoms are shown as reference character 6. The location of insertion is found along the c-axis.

Rutile has a tetragonal unit cell with a space group of P42/mm. Two sites are available for magnesium ion insertion along the c-axis, a high energy tetrahedral site and a low energy octahedral site. The high energy tetrahedral site is at (x, x, 0.5), (0<x<0.3), and the low energy octahedral site is (0.5, 0, 0.5), and (0, 0.5, 0.5). Experimentally, applicants have determined that with respect to the lithium ion, the tetrahedral site has an energy that is 0.7 evper ion higher than the octahedral site, and is thus inaccessible at ambient temperature.

Based on the foregoing, the feasible insertion of the magnesium ion occurs at the (0, 0.5, z) position, and the equilibrium position for the magnesium ion is at (0, 0.5, 0.5). When the magnesium ion is inserted, the stoichiometric formula is Mg_{0.065}TiO₂. The binding energy for the magnesium ion is about 1.67 ev, as compared with 1.56 eV for the lithium ion.

Further, the energy of insertion of the magnesium ion into the rutile structure has an energy change of about −1.81 eV per magnesium atom, wherein magnesium metal is in the anode material. Accordingly, the cell voltage for such a battery would be about 0.9 V.

As a result of the intercalation, the rutile unit cell expands slightly. At a concentration of about 0.0625 magnesium ions per titanium component of the rutile, the expansion of the rutile unit cell is approximately one percent with respect to the unintercalated titanium dioxide rutile structure. This expansion is comparable to that of the lithium ion at that concentration.

Further, at a concentration of about 0.5 magnesium ions per titanium component of rutile, the expansion is estimated to be about ten percent, as compared with a value of about six percent for the lithium ion at that concentration. While the magnesium ion is smaller than the lithium ion, the expansion force is stronger for the magnesium ion. For example, but not by way of limitation, the Ti—O bond of the rutile structure expands from 1.96 angstroms to 1.97 angstroms for the lithium ion as the intercalant, and to 1.97 angstroms for magnesium ion as the intercalant.

Once the magnesium ion is intercalated by the rutile structure, the degree of success of the magnesium ion insertion can be determined by the positive charge of the magnesium ion. In the foregoing exemplary, non-limiting embodiment of the present invention, the magnesium ion has a positive charge of about +1.74 in the host. This indicates that the titanium atom in rutile is reduced upon the insertion of the magnesium atom. The electrons from the magnesium ion are transferred to both the titanium atom and the oxygen atoms in the unit cell. More specifically, about forty percent of the charge is transferred to the titanium, and about sixty percent of the charge is transferred to the oxygen.

The intercalation of magnesium is shown by estimation of the charge distribution of the host material before and after the insertion of the magnesium ion. Additionally, this intercalation can be shown by estimating the charge distribution profile of the magnesium ion in rutile. Based on simulations performed by applicants, the mobility of the magnesium ion is in a range suitable for practical applications, such as video recorders, compact disk players, personal computers, and similar low power applications.

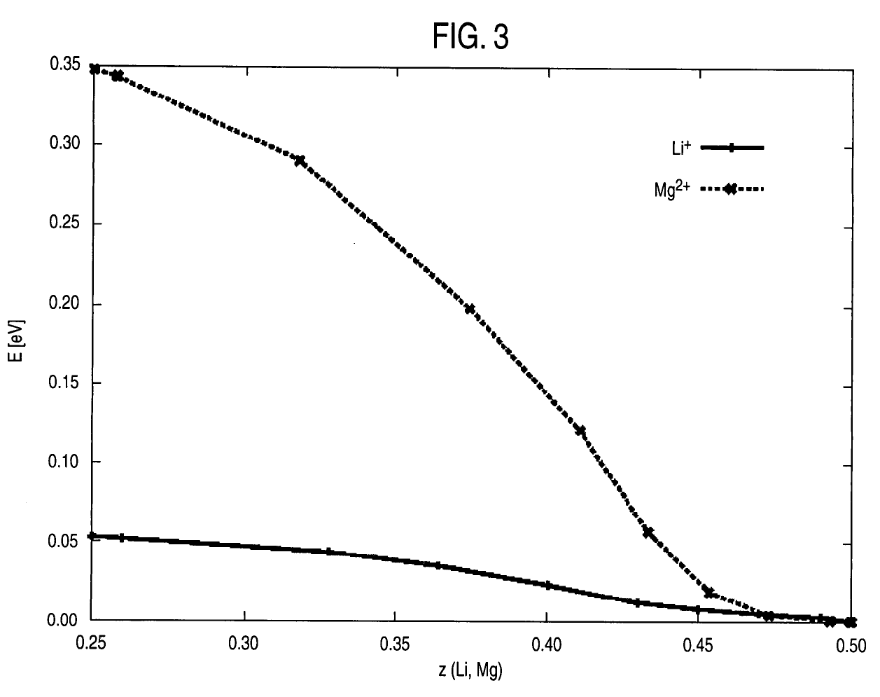

FIG. 3 provides an illustration of the energy cost for the movement of the magnesium ions along the c-axis of the rutile structure. The transition state is at (0,0.5,0.25), and the activation energy for the movement is about 0.35 eV. Further, the diffusion constant is estimated to be about 10⁻¹¹ cm²s⁻¹, accurate to within two orders of magnitude. This diffusion constant is comparable to various related art hosts used with lithium (for example, Li₁₋ₓNiO₂) . However, the diffusion constant for use of lithium with the rutile structure is about 10⁻⁶ cm²s⁻¹. As noted above, hosts other than rutile are recommended for use with lithium, as there are limitations of lithium with rutile in terms of volume density and voltage.

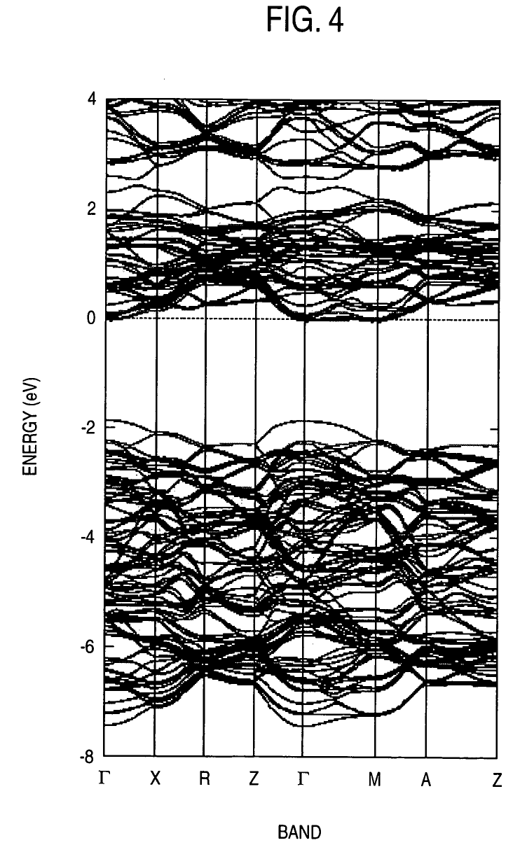

FIGS. 4-6 illustrate a comparison of the band structures of rutile prior to intercalation, intercalated lithium ion, and intercalated magnesium ion, respectively. As illustrated in FIG. 4, the band gap of the rutile structure alone is known, and has a theoretical value of 3.0 eV and a calculated value of 1.67 eV. This discrepancy is a well-known deficiency of the density functional theory. The valence band is from about −6 eV to 0 eV, and consists mainly of the oxygen 2p states, with considerable mixing with the titanium d states. The calculated bandwidth is about 5.73 eV. The conduction band formally includes the d states split into two groups. In the octahedral environment, the d states are split into t2g and eg states of an atom. The conduction band at about 2 eV to 4 eV corresponds to the t2g states.

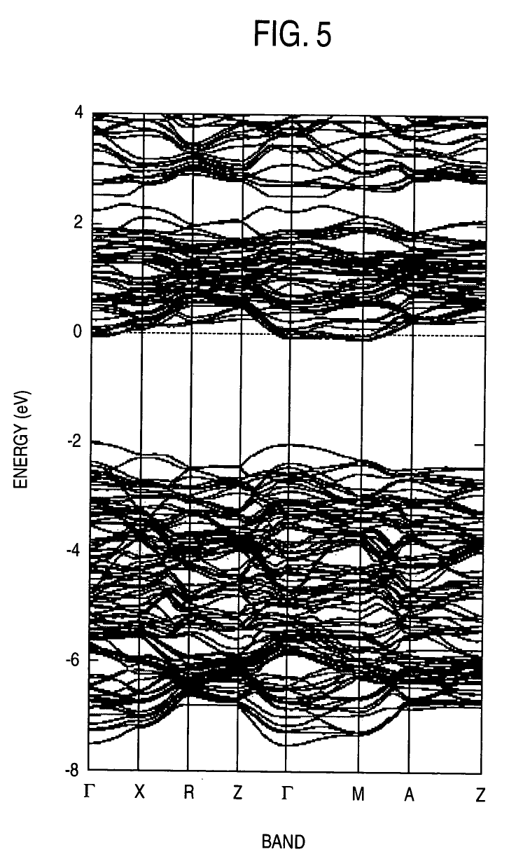

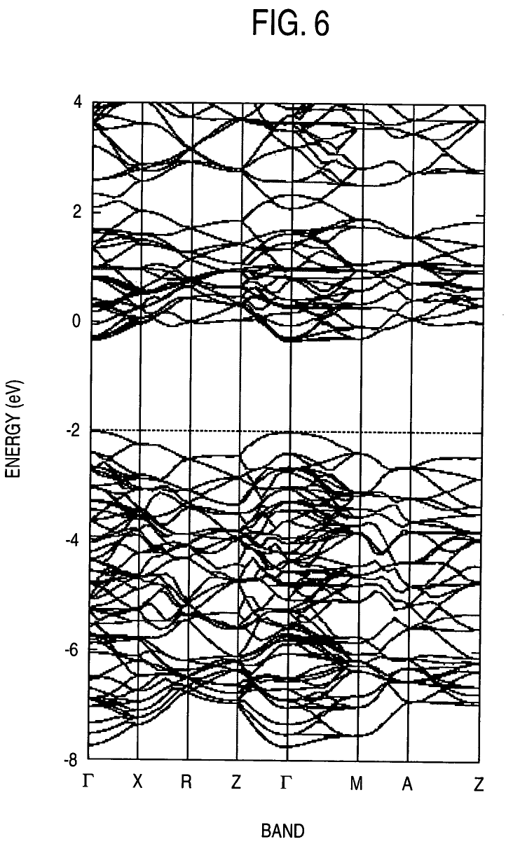

Upon intercalation with either the lithium ion or the magnesium ion as illustrated in FIGS. 5 and 6, respectively, the essential features of the band structures remain unchanged. However, certain features do change. For example, but not by way of limitation, the band gap increases and the bandwidth decreases, despite the denaturing due to the above-discussed distortion of the crystalline structure. For the lithium ion, the band gap increases from its unintercalated value of 1.67 eVto a value of 1.82 eV after intercalation, and for the magnesium ion, the band gap increases to a value of 1.94 eV after intercalation. However, the oxygen 2p widths decrease to 5.59 for the lithium ion and 5.49 for the magnesium ion. While the ionicity of the structures increases, the hybridization between the oxygen and titanium d states decreases.

FIG. 7 illustrates a method of manufacturing the cathode terminal material according to an exemplary, non-limiting embodiment of the present invention. In this process, commercially available rutile is used. For example, but not by way of limitation, commercial titanium dioxide powder (rutile) can be used.

In a first step S1, the rutile nanoparticles are produced. In one process for producing the rutile nanoparticles, the rutile powder is positioned in a zirconia (ZrO₂)pot, and is mechanically ground, or milled, into nanoparticles. In an exemplary implementation of this step, the rutile powder is mechanically ground by a planetary ball mill.

Typically, the planetary ball operates between about 500 revolutions per minute (rpm) and 1000 rpm, preferably at approximately 700 rpm, for about 3 to 12 hours. This mechanical grinding process can produce rutile particles having a diameter between about 100 nm and 1000 nm, depending on the exact amount of grinding performed. In the foregoing preferred embodiment, the rutile particle diameter is about 100 nm.

In an alternative process for producing the rutile nanoparticles, the rutile powder may be sealed in a quartz tube with an oxygen partial pressure of less than about 0.01 bar of oxygen. The foregoing atmospheric condition can result in a reducing atmosphere. The specimen is then annealed at less than about 400 degrees Celsius (preferably between about 300 and 400 degrees Celsius) for at least approximately 6 hours, and preferably about 12 hours. Next, the specimen is quenched to approximately 0 to 30 degrees Celsius by dumping the sample in water at room temperature.

In yet another alternative process for formation of rutile nanoparticles, the titanium dioxide powder can be synthesized via a sol-gel/hydrothermal process. Preferably, nitric acid is used as a catalyst, and commercial titanium alkoxide is diluted by ethanol, and then added to water. After the resulting solution has been stirred for about two hours, a precipitate is filtered and added into concentrated nitric acid solution. Within a few minutes, the solid dissolves, and the solution is stirred below approximately 45 degrees Celsius for at least about 24 hours.

As a result, the rutile powder re-precipitates, and is filtered and dried at below approximately 100 degrees Celsius, within a preferred range of about 90 to 100 degrees Celsius. Because the preferred solvent in this process is water, the temperature should not exceed 100 degrees Celsius.

This process is believed to produce rutile particles having a diameter range from about 30 nm to 70 nm, preferably about 50 nm.

In the foregoing methods of forming the nanoparticles of rutile, the structure can be confirmed to have the rutile structure by way of x-ray diffraction (XRD) spectroscopy.

Once the foregoing step S1 has been completed and the rutile nanoparticles are formed, each nanoparticle has a generally spherical shape. A small size rutile particle having the preferred diameter disclosed above is necessary due to the low diffusion constant of magnesium.

Alternative to the foregoing formation of spherical nanoparticles, elongated fibers may be produced as the rutile nanoparticles. These fibers can be produced in a manner similar to that shown in the Omaru patent for the formation of carbon fibers, or any other related art method of producing elongated rutile fibers.

In a second step S2, the milled nanoparticles are then mixed with carbon and polyvinylidene fluoride (PVDF), having the chemical formula —(CH₂CF₂)—ₙ to increase the electrical conductivity of the cathode. These carbon particles can have the same size as those used in the related art lithium batteries. However, any other size or shape of nanoparticle that increases the electrical conductivity of the cathode material may also be used. In step S2, the resulting mixture can then be pressed with a stainless steel mesh, which acts as a current collector. Then, the composite electrode preparation is dried under vacuum at room temperature for about 24 hours.

The present invention has various advantages. For example, but not by way of limitation, rutile is preferable alternative over the related art because it provides an oxygen-containing compound that successfully intercalates with the magnesium ion, thus increasing voltage. Additionally, rutile is preferred due to its one-to-one magnesium-to-cathode metal ratio, thus resulting in an increased charge capacity over the related art chevrol phase cathode material.

Further, because of the higher volume density than related art lithium batteries, the magnesium battery is smaller, which increases convenience for consumers, and allows manufacturers to produce smaller devices. Additionally, because magnesium has a lower cost than lithium, the present invention also has an advantage of reducing cost to manufacturers and therefore consumers.

The present invention is not limited to the specific above-described embodiments. It is contemplated that numerous modifications may be made to the present invention without departing from the spirit and scope of the invention as defined in the following claims.

### INDUSTRIAL APPLICABILITY

The rechargeable magnesium electrochemical cell of the present invention has various industrial applications. For example, it may be used in camcorders, compact disk players, personal computers (including laptop computers), and other low-power portable devices that currently use lithium rechargeable batteries. However, the present invention is not limited to these uses, and any other use as may be contemplated by one skilled in the art may also be used.

1. An electrochemical cell, comprising:
a first terminal material including at least one magnesium ion; and
a second terminal material including a rutile structure capable of intercalating said at least one magnesium ion.

2. The electrochemical cell of claim 1, wherein said rutile structure comprises a crystalline structure that includes a compound having the formula MₓO₂, wherein M represents a metal atom.

3. The electrochemical cell of claim 2, wherein said crystalline structure is an active material and said formula is TiO₂.

4. The electrochemical cell of claim 3, wherein electrons from said at least one magnesium ion are transferred to Ti and O₂ of said TiO₂.

5. The electrochemical cell of claim 1, wherein said rutile structure is electrically conductive and ionically conductive.

6. The electrochemical cell of claim 1, wherein said rutile structure intercalates said at least one magnesium ion at an octahedral site of a unit cell of said rutile structure.

7. The electrochemical cell of claim 1, wherein an energy of insertion for intercalating said at least one magnesium ion into said rutile structure is 1.81 eV, and a voltage of said electrochemical cell is 0.9 V.

8. The electrochemical cell of claim 1, wherein said rutile structure expands by one percent when a concentration of 0.0625 magnesium ions per molecule of said rutile structure exists in said electrochemical cell, and said rutile structure expands by ten percent when a concentration of 0.5 magnesium ions per molecule of said rutile structure exists in said electrochemical cell.

9. The electrochemical cell of claim 1, wherein when said at least one magnesium ion has been intercalated into said rutile structure, the at least one magnesium ion has a charge of 1.74 e.

10. The electrochemical cell of claim 1, wherein said rutile structure comprises at least one nanoparticle and carbon as a mixture.

11. The electrochemical cell of claim 10, wherein said at least one nanoparticle is substantially round and has a diameter of between 100 nm and 1000 nm.

12. The electrochemical cell of claim 11, wherein said at least one nanoparticle is substantially round and has a diameter of 100nm.

13. The electrochemical cell of claim 10, wherein said at least one nanoparticle is substantially round and has a diameter of between 30 nm and 70 nm.

14. The electrochemical cell of claim 13, wherein said at least one nanoparticle is substantially round and has a diameter of 50 nm.

15. The electrochemical cell of claim 10, wherein said at least one nanoparticle is an elongated fiber.

16. The electrochemical cell of claim 10, wherein said at least one nanoparticle is reduced to increase electrical conductivity.

17. The electrochemical cell of claim 1 , wherein said first terminal material is at an anode and said second terminal material is at a cathode.

18. The electrochemical cell of claim 17, wherein said anode comprises one of a carbon nanotube, a graphite structure, titanium disulfide, MgZn₂ and MgCu₂.

19. The electrochemical cell of claim 1, wherein said electrochemical cell is rechargeable.

20. The electrochemical cell of claim 1, further comprising an electrolyte that includes one of:
(a) Mg(ClO₄)₂ in one of (i) a propylene carbonate (—(OC(O)OCH(CH₃)CH₂)—)solvent and (ii) an acetonitrile (CH₃CN) solvent; and
(b) Mg[(CF₃SO₂)₂N]₂ in one of (i) a tetrohydrofuran (THF) solvent having a chemical formula of —(CH₂CH₂CH₂CH₂O)—, (ii) a dimethyl formamide (DMF) solvent having a chemical formula of (CH₃)₂NCHO, (iii) a. butyrolactone solvent having a chemical formula of —(OC (O)CH₂CH₂CH₂)—, and (iv) the propylene carbonate solvent.
wherein said electrolyte is interposed between said first terminal material and said second terminal material.

21. An electrode material for an electrochemical cell, wherein said electrode material has a rutile structure and is capable of intercalating at least one magnesium ion.

22. The electrode material of claim 21, wherein said rutile structure comprises a crystalline structure that includes a compound having the formula MₓO₂, wherein M represents a metal atom.

23. The electrode material of claim 21, wherein said crystalline structure is an active material and said formula is TiO₂.

24. The electrode material of claim 22, wherein electrons from said at least one magnesium ion are transferred to Ti and O₂ of said TiO₂.

25. The electrode material of claim 21, wherein said rutile structure is electrically conductive and ionically conductive.

26. The electrode material of claim 21, wherein said rutile structure intercalates said at least one magnesium ion at an octahedral site of a unit cell of said rutile structure.

27. The electrode material of claim 21, wherein an energy of insertion for intercalating said at least one magnesium ion into said rutile structure is 1.81 eV, and a voltage of said electrochemical cell is 0.9 V.

28. The electrode material of claim 21, wherein said rutile structure expands by one percent when a concentration of 0.0625 magnesium ions per molecule of said rutile structure exists in said electrode material, and said rutile structure expands by ten percent when said a concentration of 0.5 magnesium ions per molecule of said rutile structure exists in said electrode material.

29. The electrode material of claim 21, wherein when said at least one magnesium ion has been intercalated into said rutile structure, the at least one magnesium ion has a charge of 1.74 e.

30. The electrode material of claim 21, wherein said rutile structure comprises at least one nanoparticle and carbon as a mixture.

31. The electrode material of claim 30, wherein said at least one nanoparticle is substantially round and has a diameter of between 100 nm and 1000 nm.

32. The electrode material of claim 31, wherein said at least one nanoparticle is substantially round and has a diameter of 100 nm.

33. The electrode material of claim 30, wherein said at least one nanoparticle is substantially round and has a diameter of between 30 nm and 70 nm.

34. The electrode material of claim 33, wherein said at least one nanoparticle is substantially round and has a diameter of 50 nm.

35. The electrode material of claim 30, wherein said at least one nanoparticle is an elongated fiber.

36. The electrode material of claim 30, wherein said at least one nanoparticle is reduced to increase electrical conductivity.

37. The electrode material of claim 21, wherein said electrode material is at a cathode.

38. The electrode material of claim 21, wherein said electrochemical cell is rechargeable.

39. The electrode material of claim 21, wherein the at least one magnesium ion is received from an anode material that stores the at least one magnesium ion.

40. The electrode material of claim 39, wherein said anode material comprises one of a carbon nanotube, a graphite structure, titanium disulfide, MgZn₂ and MgCu₂.

41. A rechargeable electrochemical cell, comprising:
an anode configured to store at least one magnesium ion; and
a cathode comprising a rutile structure configured to intercalate said at least one magnesium ion.

42. The rechargeable electrochemical cell of claim 41, wherein said rutile structure comprises a crystalline structure that includes a compound having the formula M_{X}O₂, wherein M represents a metal atom.

43. The rechargeable electrochemical cell of claim 42, wherein said crystalline structure is an active material and said formula is TiO₂.

44. The rechargeable electrochemical cell of claim 43, wherein electrons from said at least one magnesium ion are transferred to Ti and O₂ of said TiO₂.

45. The rechargeable electrochemical cell of claim 41, wherein said rutile structure is electrically conductive and tonically conductive.

46. The rechargeable electrochemical cell of claim 41, wherein said rutile structure intercalates said at least one magnesium ion at an octahedral site of a unit cell of said rutile structure.

47. The rechargeable electrochemical cell of claim 41, wherein an energy of insertion for intercalating said at least one magnesium ion into said rutile structure is 1.81 eV and a voltage of said electrochemical cell is 0.9 V.

48. The rechargeable electrochemical cell of claim 41, wherein said rutile structure expands by one percent when a concentration of 0.0625 magnesium ions per molecule of said rutile structure exists in said rechargeable electrochemical cell, and said rutile structure expands by ten percent when a concentration of 0.5 magnesium ions per molecule of said rutile structure exists in said rechargeable electrochemical cell.

49. The rechargeable electrochemical cell of claim 41, wherein when said at least one magnesium ion has been intercalated into said rutile structure, the at least one magnesium ion has a charge of 1.74 e.

50. The rechargeable electrochemical cell of claim 41, wherein said rutile structure comprises at least one nanoparticle and carbon as a mixture.

51. The electrode material of claim 50, wherein said at least one nanoparticle is substantially round and has a diameter of between 100 nm and 1000 nm.

52. The electrode material of claim 51, wherein said at least one nanoparticle is substantially round and has a diameter of 100 nm.

53. The electrode material of claim 50, wherein said at least one nanoparticle is substantially round and has a diameter of between 30 nm and 70 nm.

54. The electrode material of claim 53, wherein said at least one nanoparticle is substantially round and has a diameter of 50 nm.

55. The rechargeable electrochemical cell of claim 50, wherein said at least one nanoparticle is an elongated fiber.

56. The rechargeable electrochemical cell of claim 50, wherein said at least one nanoparticle is reduced to increase electrical conductivity.

57. The rechargeable electrochemical cell of claim 41, further comprising an electrolyte that includes one of:
(a) Mg(ClO₄)₂ in one of (i) a propylene carbonate (—(OC (O) OCH (CH₃)CH₂)—) solvent and (ii) an acetonitrile (CH₃CN) solvent; and
(b) Mg[(CF₃SO₂)₂N]₂ in one of (i) a tetrohydrofuran (THF) solvent having a chemical formula of —(CH₂CH₂CH₂CH₂O)—, (ii) a dimethyl formamide (DMF) solvent having a chemical formula of (CH₃)₂NCHO, (iii) a. butyrolactone solvent having a chemical formula of —(OC(O)CH₂CH₂CH₂)—, and (iv) the propylene carbonate solvent.
wherein said electrolyte is interposed between said anode and said cathode.

58. The rechargeable electrochemical cell of claim 41, wherein said anode comprises one of a carbon nanotuber a graphite structure, titanium disulfide, MgZn₂ and MgCu₂

59. A method of manufacturing an electrode material for an electrochemical cell, comprising the steps of:
forming rutile nanoparticles having a shape and a size; and
enhancing electrical conductivity of said rutile nanoparticles by mixing said rutile nanoparticles to form a composite.

60. The method of claim 59, wherein said forming step comprises:
positioning the rutile powder in a ZrO₂ (zirconia) pot; and
milling said positioned rutile powder into nanoparticles.

61. The method of claim 60, wherein said size of said rutile nanoparticles is between 100 nm and 1000 nm.

62. The method of claim 61, wherein said size of said rutile nanoparticles is 100 nm.

63. The method of claim 60, wherein said milling step comprises mechanically grinding said rutile powder by a planetary ball mill at between 500 revolutions per minute (rpm) and 1000 rpm for 3 to 12 hours.

64. The method of claim 63, wherein said mechanical grinding is performed at 700 rpm.

65. The method of claim 59, wherein said forming step comprises:
sealing the rutile powder in a quartz tube with an oxygen partial pressure of less than 0.01 bar of oxygen, to generate a reducing atmosphere;
annealing said sealed rutile powder at a temperature less than 400 degrees Celsius for a duration at least 6 hours; and
quenching said annealed rutile powder to a range of 0 to 30 degrees Celsius.

66. The method of claim 65, wherein said temperature of said annealing is between 300 and 400 degrees Celsius, and said duration of said annealing is 12 hours.

67. The method of claim 65, wherein said size of said rutile nanoparticles is 100 nm.

68. The method of claim 59, wherein said forming step comprises:
synthesizing said rutile powder via a sol-gel/hydrothermal process, wherein nitric acid is used as a catalyst, and commercial titanium alkoxide is diluted by ethanol and added to water, to form a solution;
stirring the resulting solution for about two hours, filtering a precipitate, and adding said filtered precipitate into a concentrated nitric acid solution until the precipitate dissolves;
stirring the dissolved precipitate below 45 degrees Celsius for at least 24 hours, or until the rutile powder re-precipitates;.and
filtering and drying said re-precipitated rutile powder at between 90 and 100 degrees Celsius.

69. The method of claim 68, wherein said size of said rutile nanoparticles is between 30 nm and 70 nm.

70. The method of claim 69, wherein said size of said rutile nanoparticles is 50 nm.

71. The method of claim 59, wherein said forming of said rutile nanoparticles is confirmed by x-ray diffraction (XRD) spectroscopy.

72. The method of claim 59, wherein said enhancing step comprises:
mixing said rutile nanoparticles with carbon and polyvinylidene fluoride (PVDF) having the chemical formula —(CH₂CF₂)—ₙ to form a mixture having increased electrical conductivity;
pressing the mixture with a stainless steel mesh, which acts as a current collector to form a composite electrode material; and
drying the composite electrode material under vacuum at room temperature for about 24 hours.
